(19) United States
(12) Patent Application Publication
(10) Pub. No.: US 2025/0214358 A1
(43) Pub. Date: Jul. 3, 2025

(54) DEODORIZATION CARTRIDGE AND RECORDING DEVICE

(71) Applicant: SEIKO EPSON CORPORATION, Tokyo (JP)

(72) Inventors: Yoshihiko MOMOSE, SHIOJIRI-SHI (JP); Yoichi KOBAYASHI, MATSUMOTO-SHI (JP); Ryuji MORIYAMA, MATSUMOTO-SHI (JP)

(21) Appl. No.: 19/001,900

(22) Filed: Dec. 26, 2024

(30) Foreign Application Priority Data
Dec. 28, 2023 (JP) 2023-222300

(51) Int. Cl. B41J 29/377; B01D 53/82

(52) U.S. Cl. CPC B41J 29/377; B01D 53/82; B01D 2253/102; B01D 2257/90

(57) ABSTRACT

A deodorization cartridge for a recording device includes a deodorization body cover including a handle and an opening portion for ventilation, and a deodorization unit accommodated in the deodorization body cover, and the deodorization unit includes an activated carbon, and urethane disposed on both sides of the activated carbon in a Z-axis direction, the urethane is accommodated in the deodorization body cover in an elastically deformed state, and the opening portion causes air in the deodorization body cover to flow therethrough in the Z-axis direction.

The present application is based on, and claims priority from JP Application Serial Number 2023-222300, filed Dec. 28, 2023, the disclosure of which is hereby incorporated by reference herein in its entirety.

### BACKGROUND

### 1. Technical Field

The present disclosure relates to a deodorization cartridge and a recording device.

### 2. Related Art

In the related art, a recording device that records characters or images and has a function of purifying odors caused by recording materials is known. For example, JP-A-2018-140530 discloses a printing device that includes a printing unit, a housing that accommodates the printing unit, and a gas purification unit that purifies gas. The gas purification unit is located outside the housing and communicates with the inside of the housing via an exhaust unit and a supply unit. This printing device decomposes or removes odors of a gas inside the housing using a deodorizing agent such as an activated carbon or an ozone oxidizer.

However, when a recording device is transported or a deodorization cartridge is attached to the recording device, fine powder may be generated when a deodorization body is rubbed due to vibration and the generated fine powder may leak to the outside.

### SUMMARY

The present disclosure is a deodorization cartridge for a recording device, including: an accommodation body including a handle and an opening portion for ventilation, and a deodorization unit accommodated in the accommodation body, wherein the deodorization unit includes a deodorization body, and a first elastic body and a second elastic body disposed on both sides of the deodorization body in a first direction, the first elastic body and the second elastic body are accommodated in the accommodation body in an elastically deformed state, and the opening portion causes air in the accommodation body to flow therethrough in the first direction.

The present disclosure is a recording device including a medium support portion configured to support a medium, a recording unit configured to perform recording on the medium using a liquid, an irradiation unit configured to irradiate the medium with ultraviolet light, and a deodorization cartridge configured to deodorize odors generated from the liquid, wherein the deodorization cartridge includes an accommodation body including a handle and an opening portion for ventilation, and a deodorization unit accommodated in the accommodation body, the deodorization unit includes a deodorization body, and a first elastic body and a second elastic body disposed on both sides of the deodorization body in a first direction, the first elastic body and the second elastic body are accommodated in the accommodation body in an elastically deformed state, and the opening portion causes air in the accommodation body to flow therethrough in the first direction.

### BRIEF DESCRIPTION OF THE DRAWINGS

FIG. 1 is a perspective view of a recording device.

FIG. 2 is a plan view of the recording device.

FIG. 3 is a perspective view of the recording device.

FIG. 4 is a perspective view of a deodorization mechanism.

FIG. 5 is a perspective view of the deodorization mechanism.

FIG. 6 is a perspective view of the deodorization mechanism and a deodorization cartridge.

FIG. 7 is a perspective view of the deodorization cartridge.

FIG. 8 is a cross-sectional view of main portions of the deodorization cartridge.

FIG. 9 is a block diagram illustrating a configuration of a control system of the recording device.

### DESCRIPTION OF EMBODIMENTS

### 1. Configuration of Recording Device

A configuration of the recording device 1 of an embodiment will be described below with reference to the accompanying drawings.

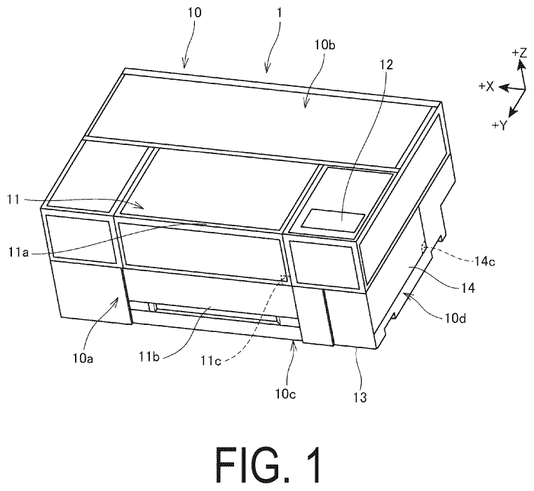

FIG. 1 is a perspective view of the recording device 1.

The recording device 1 is a device that performs recording on a medium M supported by a medium support portion 30 by ejecting a liquid from a recording head 89a. The medium M is a sheet, a cloth, or a three-dimensional object. The sheet may be paper or a sheet made of synthetic resin. The fabric may be nonwoven, knitted, or woven. The three-dimensional object may be an ornament such as clothing or shoes, daily necessities, machine parts, or various other objects. There is no restriction on a type of liquid that the recording device 1 ejects onto the medium M as long as the liquid has fluidity. For example, the recording device 1 is a printer that ejects one or more colors of ink onto a front surface of the medium M using the recording head 89a to form an image on the medium M. In this case, the medium M can be called a print medium.

FIG. 1 shows an X-axis, a Y-axis, and a Z-axis. The X-axis, the Y-axis, and the Z-axis are orthogonal to each other. The Z-axis is an axis that extends in an up-down direction, and can also be called an axis that extends in a vertical direction. The X-axis and the Y-axis are parallel to a horizontal plane. In the following description, a direction along the X-axis is a left-right direction, and a direction along the Y-axis is a front-rear direction. In detail, a positive direction along the Z-axis is an upward direction, a positive direction along the X-axis is a rightward direction, and a positive direction along the Y-axis is a forward direction.

The recording device 1 includes a housing 10. The housing 10 is a substantially rectangular box and forms a closed space inside the housing 10. The housing 10 covers a medium support portion 30, the recording head 89a, an irradiation unit 89b, a first deodorization mechanism 20, and a second deodorization mechanism 50, which will be described later, and stores these in a closed space. The housing 10 includes a front cover 11 along a front surface 10a and a top surface 10b. The front cover 11 includes a cover body 11a along the front surface 10a and the top surface 10b, and a handle 11b coupled to a lower end of the cover body 11a. The front cover 11 is coupled to the top surface 10b of the housing 10 by a hinge at a rear end of the cover body 11a so that the front cover 11 can be rotated about the left-right direction. Therefore, when the handle 11b moves in an up-down direction, the front cover 11 can be opened and closed from the forward direction. Further, the housing 10 includes a bottom plate 13 on a bottom surface 10c, which is a plate that faces an installation surface of the housing 10. The installation surface is a surface on which the housing 10 is installed, such as a top surface of a desk (not shown).

The recording device 1 includes a touch panel 12 disposed in a front portion of the top surface 10b. The touch panel 12 includes, for example, a liquid crystal panel and light emitting diodes (LEDs). The touch panel 12 is coupled to a control unit 100 installed inside the housing 10. The touch panel 12 includes a touch sensor that detects a touch operation with respect to a front surface of the touch panel 12 and a display panel that are superimposed on each other. The display panel of the touch panel 12 is, for example, a liquid crystal panel. The control unit 100 causes display of characters or images via control of the display panel of the touch panel 12. The control unit 100 also detects the touch operation with respect to the touch panel 12 and specifies an operation position of the touch operation. The control unit 100 causes the touch panel 12 to display information such as the progress of recording in the recording device 1, and a remaining amount of liquid to be ejected during recording. Further, the control unit 100 causes the touch panel 12 to display information on a replacement timing of consumables of the first deodorization mechanism 20 and the second deodorization mechanism 50 to be described below.

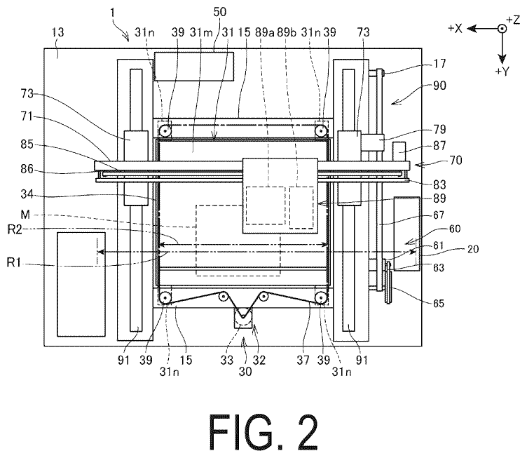

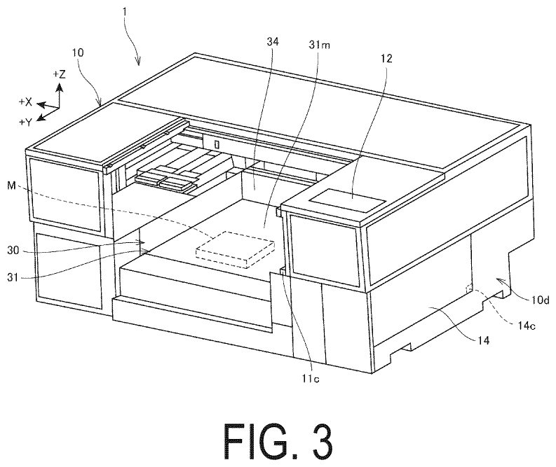

FIG. 2 is a plan view of the recording device 1, and schematically shows an internal structure of the recording device 1. FIG. 3 is a perspective view of the recording device 1. For ease of description, a state in which the front cover 11 is removed is shown in FIG. 3.

As illustrated in FIG. 2, the recording device 1 includes a pair of base members 15, a pair of guide shafts 91, the first deodorization mechanism 20, the medium support portion 30, the second deodorization mechanism 50, a drive mechanism 90, and a moving portion 70. The base member 15 is a member that extends in a left-right direction. The two base members 15 are disposed side by side in the front-rear direction on the bottom plate 13 and fixed to the bottom plate 13. The guide shaft 91 is a shaft that extends in the front-rear direction, and the two guide shafts 91 are disposed side by side in the left-right direction to straddle the two base members 15.

The first deodorization mechanism 20 and the second deodorization mechanism 50 suck air inside the housing 10 and remove odors contained in the sucked air, thereby deodorizing the air and exhaust the air to the outside of the housing 10. Details of the first deodorization mechanism 20 and the second deodorization mechanism 50 will be described later.

The medium support portion 30 supports the medium M that is a recording target in the recording device 1. As illustrated in FIGS. 2 to 4, the medium support portion 30 includes a table 31, a fall prevention plate 34, and a height movement mechanism 32. The table 31 is disposed at a position surrounded by the pair of base members 15 and the pair of guide shafts 91 in a plan view. The table 31 includes a support surface 31m that is a rectangular surface that is along the X-axis and Y-axis and faces upward.

The support surface 31m is a surface on which the medium M is placed in the medium support portion 30, and supports the medium M placed on the support surface 31m. As illustrated in FIG. 3, the support surface 31m is exposed to the front side and the top side of the housing 10 in a state in which the front cover 11 is open. Therefore, the medium M outside the housing 10 can be set on the support surface 31m of the medium support portion 30 from the front side of the support surface 31m in a state in which the front cover 11 is open. Further, the medium M placed on the support surface 31m of the medium support portion 30 can be removed to the outside of the housing 10 in a state in which the front cover 11 is open.

The table 31 includes protrusions 31n that protrude outward from the support surface 31m in a plan view in lower portions at four corners of the support surface 31m. The table 31 is supported to be raised or lowered with respect to the base member 15 by the protrusions 31n being fixed to a lifting mechanism 39 to be described later.

The fall prevention plate 34 is a plate-like member that is vertically erected in contact with left, right, and rear sides of the support surface 31m. In other words, the fall prevention plate 34 is perpendicular to the support surface 31m, and surrounds the support surface 31m in a left-right direction and the rear side along ends of the support surface 31m, and the front side of the support surface 31m is open without the fall prevention plate 34.

The fall prevention plate 34 is formed, for example, by a single sheet of metal being bent. The fall prevention plate 34 is disposed around the support surface 31m, for example, so that the medium M, which is greatly smaller than the support surface 31m, does not fall from the support surface 31m. The support surface 31m can be raised or lowered as described later, and the fall prevention plate 34 is fixed not to be raised or lowered. The fall prevention plate 34 extends in a range including a lowest position to a highest position of the support surface 31m in a height direction. Therefore, at least a portion of the fall prevention plate 34 is located above the support surface 31m when the support surface 31m is at a lowest position.

The height movement mechanism 32 raises and lowers the table 31 up and down. The height movement mechanism 32 can move the support surface 31m up and down and raise and lower the medium M supported on the support surface 31m by raising and lowering the table 31. The height movement mechanism 32 includes a lifting motor 33, a lifting belt 37, and the lifting mechanism 39. The lifting mechanism 39 includes ball screws disposed along a vertical direction, nuts screwed to the ball screws, and a pulley. The ball screw of the lifting mechanism 39 is rotatably supported by the base member 15. The nut of the lifting mechanism 39 is fixed to the protrusion 31n of the table 31. The recording device 1 includes a set of lifting mechanisms 39 each including the ball screw, a nut, and a pulley, for example, to correspond to four protrusions 31n provided at four corners of the table 31. The pulley of the lifting mechanism 39 is fixed to an upper portion of the ball screw. When the pulley of the lifting mechanism 39 rotates, the ball screw rotates, and the protrusion 31n moves in a vertical direction together with the nut as the ball screw rotates.

The lifting motor 33 is a motor that rotates under the control of the control unit 100. The control unit 100 controls a direction and amount of rotation of the lifting motor 33. The lifting belt 37 is a circular belt that is hung around an output shaft of the lifting motor 33 and the pulleys of the four lifting mechanisms 39. The lifting belt 37 is driven in a circulating manner as the lifting motor 33 rotates. The lifting belt 37 transfers the rotation of the lifting motor 33 to the pulleys of the four lifting mechanisms 39. Accordingly, the ball screw of the lifting mechanism 39 rotates to move the table 31 in a vertical direction. Since the four lifting mechanisms 39 are operated in conjunction with each other by the lifting belt 37 to move the table 31, for example, the table 31 can be raised and lowered with the horizontality of the support surface 31m maintained.

The rotation direction of the lifting motor 33 can be switched between a forward direction in which the table 31 is moved upward, and a backward direction in which the table 31 is moved downward. The recording device 1 raises and lowers the table 31 by operating the lifting motor 33.

The drive mechanism 90 includes a pair of guide shafts 91 and a frame drive unit 60. The guide shaft 91 is a shaft-shaped member that is hung across the pair of base members 15 and disposed along the front-rear direction.

The frame drive unit 60 includes a frame movement motor 61, a transfer belt 63, a speed change mechanism 65, and a transfer belt 67. The frame movement motor 61 is a motor that rotates under the control of the control unit 100. The transfer belt 63 is a circular belt that is hung between an output shaft of the frame movement motor 61 and the speed change mechanism 65, and transfers a driving force of the frame movement motor 61 to the speed change mechanism 65. The speed change mechanism 65 includes a first pulley and a second pulley, and the transfer belt 63 is wound around the first pulley and the transfer belt 67 is wound around the second pulley. The speed change mechanism 65 drives the transfer belt 67 by rotating the second pulley with a driving force transferred from the transfer belt 63 to the first pulley. The speed change mechanism 65 transfers a driving force of the frame movement motor 61 to the transfer belt 67 at a deceleration ratio corresponding to a ratio of diameters of the first pulley and the second pulley.

The transfer belt 67 is a circular belt that is hung between the speed change mechanism 65 and a frame movement pulley 17 that is disposed at an end of the base member 15 in a backward direction. The frame movement pulley 17 is a pulley that is rotatably installed on the base member 15. The transfer belt 67 is disposed along the guide shaft 91.

The moving portion 70 includes a main frame 71, a pair of leg portions 73, and a carriage 89. The main frame 71 is a plate-shaped member that is long in a left-right direction. The pair of leg portions 73 can be fitted into the pair of guide shafts 91 and moved along the guide shafts 91. The main frame 71 is fixed onto the pair of leg portions 73 and supported from a downward side by the pair of leg portions 73. The main frame 71 is guided by the pair of guide shafts 91 together with the pair of leg portions 73 and moved in the front-rear direction.

Among the pair of leg portions 73, the leg portion 73 that supports a left end of the main frame 71 is fixed to the transfer belt 67 via a belt coupling portion 79. Therefore, when the transfer belt 67 is driven in a circulating manner, a force for moving the leg portion 73 in the front-rear direction acts on the leg portion 73. Accordingly, the moving portion 70 moves in the front-rear direction. The lower end of the main frame 71 is located above the support surface 31m when the table 31 is located at an uppermost position. The main frame 71 therefore moves above the support surface 31m in the front-rear direction without interfering with the support surface 31m.

A rotation direction of the frame movement motor 61 can be switched between a forward direction in which the main frame 71 is moved forward and a backward direction in which the main frame 71 is moved backward. The recording device 1 moves the main frame 71 forward and backward by operating the frame movement motor 61.

The carriage 89 is a substantially rectangular box, and is supported by the main frame 71 via a carriage guide shaft 83. The carriage guide shaft 83 is an axial member fixed to the main frame 71, and extends in a left-right direction along the main frame 71. The carriage guide shaft 83 supports the carriage 89 so that the carriage 89 can move in a left-right direction. A lower end of the carriage 89 is located above the support surface 31m when the table 31 is located at an uppermost position. Therefore, the carriage 89 moves above the support surface 31m in the front-rear direction and the left-right direction without interfering with the support surface 31m.

Further, the carriage 89 is coupled to a carriage drive belt 85. The carriage drive belt 85 is a circular belt that is disposed along the carriage guide shaft 83, with one end hung around a carriage drive pulley 86 and the other end hung on an output shaft of a carriage drive motor 87. The carriage drive pulley 86 is a pulley that is rotatably fixed to a right end of the main frame 71. The carriage drive motor 87 is a motor that is fixed to the left end of the main frame 71 and rotates the output shaft under the control of the control unit 100. The carriage drive motor 87 drives the carriage drive belt 85 in a circulating manner by rotating the output shaft. Accordingly, the carriage drive motor 87 moves the carriage 89 coupled to the carriage drive belt 85 in the left-right direction along the carriage guide shaft 83.

The drive mechanism 90, the carriage drive belt 85, the carriage drive pulley 86, and the carriage drive motor 87 correspond to an example of a moving mechanism that moves the carriage 89 relative to the medium M.

The carriage 89 includes the recording head 89a and the irradiation unit 89b. The recording head 89a includes a plurality of nozzles (not shown) that open downward from a lower end surface of the carriage 89. The recording head 89a ejects liquid from these nozzles according to driving of a piezoelectric actuator (not shown). When the recording head 89a ejects the liquid from the nozzles, the ejected liquid flies between the nozzles and the medium M placed on the table 31 and is dropped onto the medium M. In the present embodiment, the liquid ejected from the nozzles by the recording head 89a is ink that is cured by ultraviolet light. The recording head 89a records characters or images formed by the liquid on the medium M by causing the liquid to be dropped onto the medium M on the medium support portion 30. The recording head 89a corresponds to an example of a recording unit.

The irradiation unit 89b includes an irradiation window (not shown) that faces the downward side from the lower end surface of the carriage 89. The irradiation window includes a plate made of a light-transmitting material. The irradiation unit 89b emits irradiation light from a light source unit (not shown) through the irradiation window. The irradiation light emitted from the irradiation unit 89b passes an area between the irradiation window and the medium M placed on the table 31, and is radiated onto the medium M recorded by the recording head 89a. In the present embodiment, the irradiation unit 89b includes ultraviolet light emitting diode (UV-LED) that emits ultraviolet light, and the irradiation light is ultraviolet light. That is, in the present embodiment, the irradiation unit 89b irradiates the ink dropped onto the medium M and cured by ultraviolet light with the ultraviolet light, thereby adhering the ink to the medium M.

The ink ejected by the recording head 89a is a so-called UV ink that is cured by being irradiated with the ultraviolet light. Some UV inks have a unique odor. When the recording device 1 performs recording on the medium M using such an ink, the odor of the ink is present inside the housing 10. The recording head 89a moves in a front-rear direction and a left-right direction during recording, so that the odor of the ink is diffused inside the housing 10. The first deodorization mechanism 20 and the second deodorization mechanism 50 remove the odor emitted by the ink by sucking in the air inside the housing 10, and discharge the purified air.

The first deodorization mechanism 20 is disposed on the left side of the medium support portion 30 as illustrated in FIG. 2. The first deodorization mechanism 20 is within a range R1 in which the carriage 89 moves in a left-right direction. In the range R1, a range in which the recording head 89a performs recording on the medium M is defined as a recording range R2. The recording range R2 is a range in which the recording head 89a faces the support surface 31m in the direction along the X-axis. In the range R1, a range other than the recording range R2 is defined as a retraction range. In the retraction range, the recording head 89a does not face the support surface 31m. The first deodorization mechanism 20 is disposed so that at least a portion of the first deodorization mechanism 20 is located in the retraction range as illustrated in FIG. 2. A position of the first deodorization mechanism 20 is a position that is close to a position of the recording head 89a when the recording head 89a ejects ink, and does not interfere with the ejection of ink in the recording head 89a. Therefore, it is possible to efficiently deodorize the odor of the ink that is used for recording without affecting the recording operation of the recording device 1 by using the first deodorization mechanism 20.

The second deodorization mechanism 50 is disposed behind the medium support portion 30, as illustrated in FIG. 2. The second deodorization mechanism 50 is located between the pair of guide shafts 91 in the direction along the X-axis, and at least a portion of the second deodorization mechanism 50 overlaps the support surface 31m. The second deodorization mechanism 50 is disposed behind the table 31 in the direction along the Y-axis. Further, the second deodorization mechanism 50 is disposed on the opposite side to the front cover 11 with the medium support portion 30 interposed therebetween. A position of the second deodorization mechanism 50 is a position that close to the position of the recording head 89a when the recording head 89a ejects ink, and does not interfere with the ejection of the ink in the recording head 89a. Therefore, it is possible to efficiently deodorize the odor of the ink that is used for recording without affecting the recording operation of the recording device 1 by using the second deodorization mechanism 50.

One of the first deodorization mechanism 20 and the second deodorization mechanism 50, which are the two deodorization mechanisms of the recording device 1 is at a position aligned with the support surface 31m in the direction along the X-axis, and the other is at a position aligned with the support surface 31m in the direction along the Y-axis. The first deodorization mechanism 20 is at a position suitable for deodorization of odors that are diffused by the carriage 89 moving along the X-axis. The second deodorization mechanism 50 is at a position suitable for deodorization of odors that are diffused by the carriage 89 moving along the Y-axis together with the moving portion 70. Thus, the first deodorization mechanism 20 and the second deodorization mechanism 50, which are a plurality of deodorization mechanisms, are disposed at positions aligned with the medium support portion 30 in the direction along the X-axis and positions aligned with the medium support portion 30 in the direction along the Y-axis, so that the air inside the housing 10 can be deodorized efficiently.

The first deodorization mechanism 20 and the second deodorization mechanism 50 are fixed to the base member 15 or the bottom plate 13 by a means such as screws.

In the configuration illustrated in FIG. 2, the first deodorization mechanism 20 and the second deodorization mechanism 50 are disposed so that at least a portion of the medium support portion 30 overlaps a position between the first deodorization mechanism 20 and the second deodorization mechanism 50 in a plan view. This configuration allows the odor of the ink ejected by the recording head 89a onto the medium support portion 30 to be deodorized more efficiently.

In the configuration illustrated in FIG. 2, in a configuration in which the medium support portion 30 has the rectangular table 31, the first deodorization mechanism 20 and the second deodorization mechanism 50 are disposed to correspond to one of four sides constituting the periphery of the table 31.

In other words, the first deodorization mechanism 20 and the second deodorization mechanism 50 are disposed to face one of the four sides constituting the periphery of the table 31. In this configuration, the first deodorization mechanism 20 and the second deodorization mechanism 50 are disposed so that a side of the table 31 facing the first deodorization mechanism 20 and a side of the table 31 facing the second deodorization mechanism 50 do not face each other.

Further, in the configuration illustrated in FIG. 2, the first deodorization mechanism 20 and the second deodorization mechanism 50 are disposed not to face each other across the medium support portion 30.

### 2. Configuration of Deodorization Mechanism

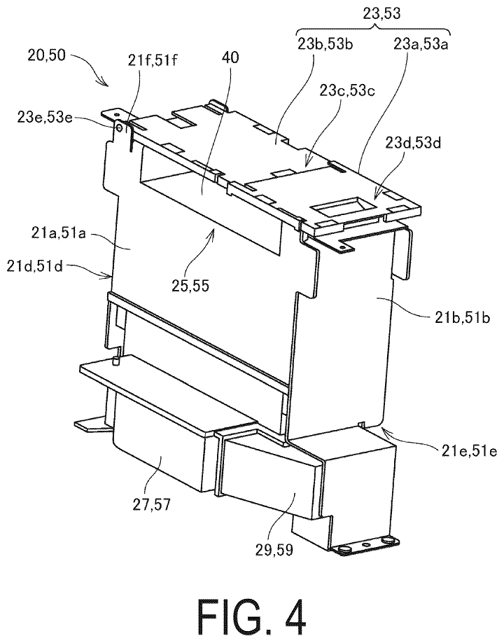

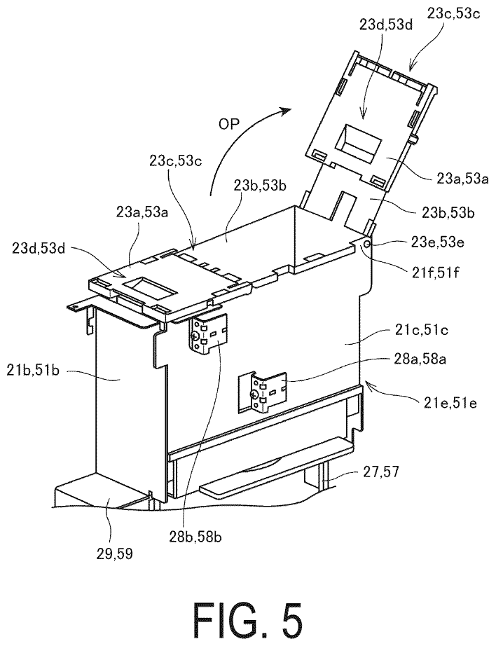

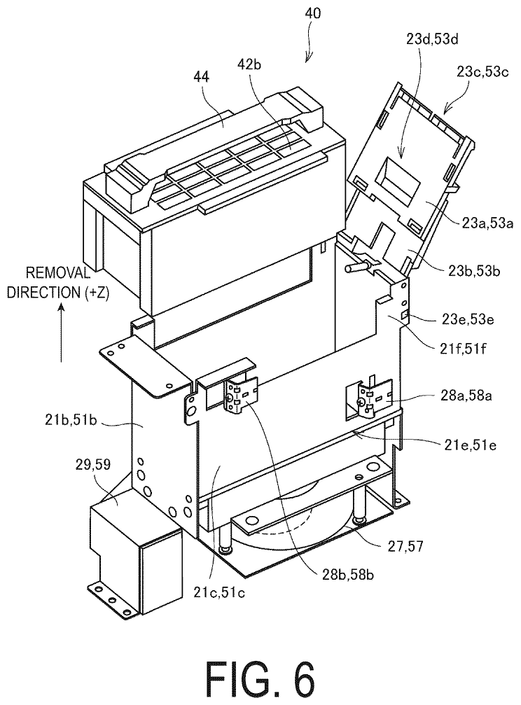

FIGS. 4 and 5 are perspective views of the deodorization mechanism, and FIG. 6 is a perspective view of the deodorization mechanism and a deodorization cartridge 40. FIG. 4 is a perspective view of the deodorization mechanism from the front, and FIG. 5 is a perspective view of the deodorization mechanism from the rear. FIG. 6 illustrates a state in which the deodorization cartridge 40 accommodated in the deodorization mechanism has been removed.

The first deodorization mechanism 20 and the second deodorization mechanism 50 have a common configuration. Hereinafter, a configuration of the first deodorization mechanism 20 will be described, but the description also applies to the second deodorization mechanism 50.

An up-down direction in FIGS. 4 and 5 corresponds to an up-down direction when the first deodorization mechanism 20 and the second deodorization mechanism 50 are mounted on the recording device 1.

The first deodorization mechanism 20 includes an accommodation portion 21, a lid portion 23, a first blower 27, and a duct 29. The second deodorization mechanism 50 includes an accommodation portion 51, a lid portion 53, a second blower 57, and a duct 59. The first blower 27 and the second blower 57 correspond to blower fans.

The accommodation portion 21 has a substantially box shape and includes a front surface 21a, a side surface 21b, a side surface 21d, a rear surface 21c, and a bottom surface 21e. The front surface 21a, the side surface 21b, the side surface 21d, the rear surface 21c, and the bottom surface 21e are all made of a surface material made of a non-flammable or flame-retardant material. For example, the accommodation portion 21 is made of a metal plate such as a steel plate. A top surface of the accommodation portion 21 is open, and the lid portion 23 is disposed to cover this opening.

The front surface 21a is a surface that faces the rear surface 21c, and the side surface 21b is a surface that faces the side surface 21d. Lid support portions 21f are provided at upper ends of the side surfaces 21b and 21d. The lid support portions 21f protrude toward the outside of the accommodation portion 21 at the side surfaces 21b and 21d. The lid support portion 21f on the side surface 21b and the lid support portion 21f on the side surface 21d face each other.

The lid portion 23 has a configuration in which a tip panel 23a and a base panel 23b are included and are coupled by a hinge portion 23c. A base end portion of the base panel 23b is pivotably coupled to the lid support portion 21f on the side surface 21b and the lid support portion 21f on the side surface 21d via the support portion 23e. A tip end portion of the base panel 23b is pivotably coupled to a base end portion of the tip panel 23a by the hinge portion 23c. Accordingly, the tip panel 23a and the base panel 23b are pivotable relative to each other, and the base panel 23b is pivotable relative to the accommodation portion 21. The tip panel 23a and the base panel 23b are made of, for example, a synthetic resin. The tip panel 23a and the base panel 23b may be made of a surface material made of a non-flammable or flame-retardant material, like the front surface 21a, the side surfaces 21b and 21d, the rear surface 21c, and the bottom surface 21e.

The tip panel 23a has a concave portion 23d formed therein. The concave portion 23d is used for a user to place his or her finger when the user opens the lid portion 23.

A first intake port 25 opens in an upper portion of the accommodation portion 21. The first intake port 25 is an opening formed by cutting out a part in an upper portion of the front surface 21a. In the present embodiment, the first intake port 25 is formed only at the front surface 21a, and not on the rear surface 21c. The front surface 21a is a surface that faces the medium support portion 30 in a state in which the first deodorization mechanism 20 is mounted on the recording device 1. The first intake port 25 can also be provided on a surface other than the front surface 21a in the accommodation portion 21. However, an air flow in the first deodorization mechanism 20 can be limited to a specific direction, and deodorization in the first deodorization mechanism 20 can be performed more efficiently by providing the first intake port 25 only on the front surface 21a.

The deodorization cartridge 40 is accommodated in the accommodation portion 21. The first intake port 25 opens on the side surface 21b, so that a top surface of the deodorization cartridge 40 is exposed inside the housing 10. The deodorization cartridge 40 is removably accommodated in the accommodation portion 21, and the deodorization cartridge 40 can be replaced.

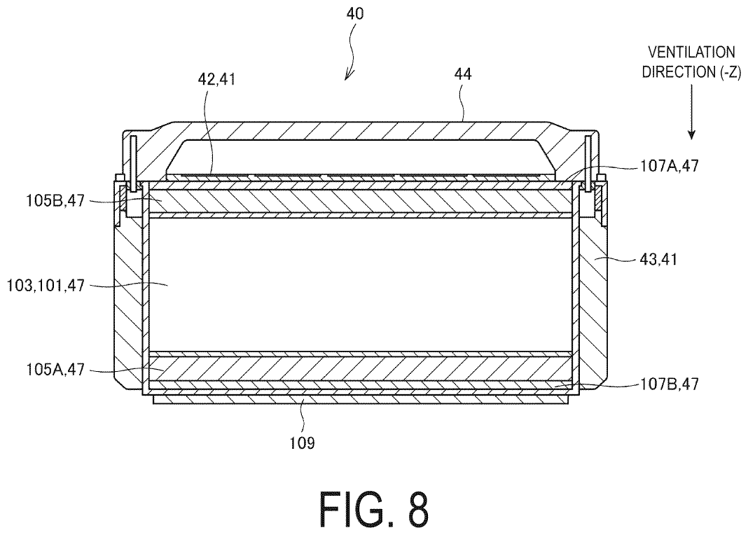

Further, the deodorization cartridge 40 is accommodated in the accommodation portion 21 through resin member for shake prevention 109. FIG. 8 illustrates an example in which the resin member 109 is provided on a bottom surface of the deodorization cartridge 40. This can curb shaking of the deodorization cartridge 40 accommodated in the accommodation portion 21, and curb leakage of a powder of the deodorization body to the outside.

The first blower 27 is mounted in a lower portion of the accommodation portion 21. The first blower 27 includes a fan (not shown) and a casing surrounding the fan. The fan of the first blower 27 faces the inside of the accommodation portion 21 through an opening (not shown) formed in the bottom surface 21e. An opening is provided in the casing of the first blower 27, and the duct 29 is coupled to the first blower 27 so that this opening is covered.

The first blower 27 sucks the air inside the accommodation portion 21 and exhausts the air to the duct 29. The duct 29 guides the exhaust air of the first blower 27 downward from the first deodorization mechanism 20. The air inside the housing 10 is sucked from the first intake port 25 according to an operation of the first blower 27. This air passes through the inside of the accommodation portion 21, passes through the first blower 27 and the duct 29, and is exhausted from a lower portion of the first deodorization mechanism 20. Since the inside of the housing 10 becomes under negative pressure by the air being exhausted, fresh air can be taken into the inside of the housing 10 from the outside of the housing 10.

As described above, the first deodorization mechanism 20 and the second deodorization mechanism 50 have a common configuration. For example, the second deodorization mechanism 50 includes the accommodation portion 51 corresponding to the accommodation portion 21, the lid portion 53 corresponding to the lid portion 23, the second blower 57 corresponding to the first blower 27, and the duct 59 corresponding to the duct 29. The accommodation portion 51 includes a front surface 51a, a side surface 51b, a side surface 51d, a rear surface 51c, and a bottom surface 51e, similar to the accommodation portion 21, and a second intake port 55 opens on the front surface 51a in an upper portion of the accommodation portion 51. The lid portion 53 includes a tip panel 53a, a base panel 53b, a hinge portion 53c, a concave portion 53d, and a support portion 53e, similar to the lid portion 23. These configurations correspond to the respective portions of the first deodorization mechanism 20, as illustrated in FIGS. 4 and 5.

The deodorization cartridge 40 is accommodated in the accommodation portion 51. The deodorization cartridge 40 is removably accommodated in the accommodation portion 51, and the deodorization cartridge 40 can be replaced. The deodorization cartridge 40 accommodated in the accommodation portion 51 and the deodorization cartridge 40 accommodated in the accommodation portion 21 can be the same. In other words, the deodorization cartridge 40 can be mounted on any one of the first deodorization mechanism 20 and the second deodorization mechanism 50.

### 3. Configuration of Deodorization Unit

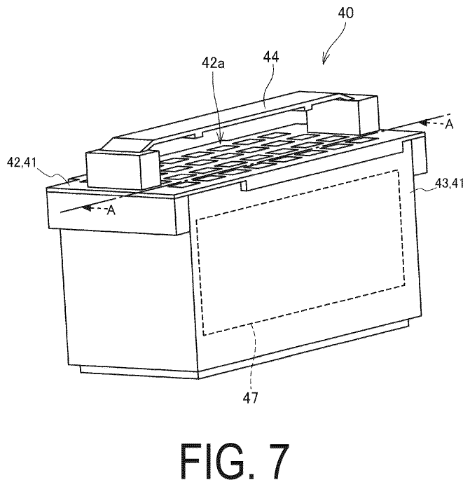

FIG. 7 is a perspective view of the deodorization cartridge 40, and FIG. 7 is a cross-sectional view of main portions of the deodorization cartridge 40. In detail, FIG. 8 is a cross-sectional view taken along line C-C illustrated in FIG. 7.

The deodorization cartridge 40 includes a deodorization body cover 41. The deodorization body cover 41 includes an upper cover 42 that forms an upper surface of the deodorization body cover 41, and a cover body 43. The cover body 43 is a substantially box-shaped container. The deodorization body cover 41 corresponds to an accommodation body.

An opening (not shown) is formed at a bottom surface of the cover body 43. In the upper cover 42, an upper surface ventilation hole 42a opens. These openings allow ventilation between an internal space of the cover body 43 and the outside. The opening formed at the bottom surface of the cover body 43 and the upper surface ventilation hole 42a correspond to an opening portion.

A handle 44 is attached to the upper cover 42. The user can lift the deodorization cartridge 40 without touching a deodorization unit 47, by holding the handle 44.

In a state in which the deodorization cartridge 40 is accommodated in the first deodorization mechanism 20, air flowing into the accommodating portion 21 from the first intake port 25 is sent to the deodorization unit 47 through the upper surface ventilation hole 42a according to the operation of the first blower 27. This air passes through the deodorization unit 47, is then discharged from an opening provided on the bottom surface of the cover body 43, and flows to the first blower 27 through the bottom surface 21e.

The front surface 21a, the side surface 21b, the rear surface 21c, the side surface 21d, and the bottom surface 21e that constitute the accommodating portion 21 are made of a non-flammable or flame-retardant material. Similarly, the front surface 51a, the side surface 51b, the rear surface 51c, the side surface 51d, and the bottom surface 51e constituting the accommodation portion 51 are made of a non-flammable or flame-retardant material. When a combustible material such as activated carbon is used as the deodorization body, it is necessary to consider the risk of fire in the deodorization unit 47. In the recording device 1, since five surfaces of the accommodation portion 21 and the accommodation portion 51 are made of a non-flammable or flame-retardant material, it is possible to minimize risk of fire occurring in the deodorization unit 47. Therefore, a combustible material can be used as the deodorization unit 47. Therefore, a degree of freedom in selecting the deodorization unit 47 is high, and the deodorization unit 47 suitable for an ink that is an odor source is used so that deodorization can be performed efficiently.

### 4. Replacement of Deodorization Unit

In the first deodorization mechanism 20 and the second deodorization mechanism 50, the deodorization cartridge 40 is replaceable. That is, the user can remove the deodorization cartridge 40 mounted on the first deodorization mechanism 20 and set a new deodorization cartridge 40 in the first deodorization mechanism 20. When an operation of replacing the deodorization cartridge 40 is performed, the user can easily handle the deodorization cartridge 40 by holding the handle 44.

As illustrated in FIG. 5, when the user places the finger in the concave portion 23d and lifts the tip panel 23a, the lid portion 23 is pivoted around the support portion 23e in a direction OP in the figure. Accordingly, the lid portion 23 is lifted and the top surface of the accommodation portion 21 is open. In a state in which the lid portion 23 is open, the tip panel 23a can be pivoted around the hinge portion 23c to fold the lid portion 23 so that the tip panel 23a and the base panel 23b overlap, as illustrated in FIG. 5. FIG. 5 illustrates the lid portion 23 both in a state in which the lid portion 23 is closed and a state in which when the lid portion 23 is open.

Since an upper portion of the accommodation portion 21 is open in a state in which the lid portion 23 is open, the user can perform an operation of removing the deodorization cartridge 40 from the accommodation portion 21 and an operation of inserting the deodorization cartridge 40 into the accommodation portion 21. This allows the deodorization cartridge 40 to be easily replaced in the first deodorization mechanism 20 and the second deodorization mechanism 50.

When the deodorization cartridge 40 is inserted into the accommodation portion 21, the user holds the handle 44 and moves the deodorization cartridge 40 in a −Z-axis direction to insert the deodorization cartridge 40 into the accommodation portion 21. Further, when the deodorization cartridge 40 is removed from the accommodation portion 21, the user holds the handle 44 and moves the deodorization cartridge 40 in a +Z-axis direction to remove the deodorization cartridge 40 from the accommodation portion 21. The Z-axis direction corresponds to a detachment direction, the +Z-axis direction corresponds to a removal direction, and the −Z-axis direction corresponds to a mounting direction. In the operation of replacing the deodorization cartridge 40, the user can remove and mount the deodorization cartridge 40 by holding the handle 44 in their hand. Accordingly, replacement of the deodorization cartridge 40 becomes a simple task.

As illustrated in FIG. 5, a first deodorization body sensor 28a and a first lid sensor 28b are disposed on the rear surface 21c of the first deodorization mechanism 20. The first deodorization body sensor 28a is a sensor that detects whether or not the deodorization cartridge 40 is accommodated in the accommodation portion 21. The first lid sensor 28b is a sensor that detects whether or not the lid portion 23 is closed. The first deodorization body sensor 28a and the first lid sensor 28b are configured as, for example, a switch-type sensor or a reflective optical sensor.

Similarly, a second deodorization body sensor 58a and a second lid sensor 58b are disposed on the rear surface 51c of the second deodorization mechanism 50. The second deodorization body sensor 58a is a sensor that detects whether or not the deodorization cartridge 40 is accommodated in the accommodation portion 51. The second lid sensor 58b is a sensor that detects whether or not the lid portion 53 is closed. The second deodorization body sensor 58a and the second lid sensor 58b are configured as, for example, a switch type sensor or a reflective optical sensor.

The first deodorization body sensor 28a and the first lid sensor 28b are coupled to the control unit 100. The control unit 100 detects whether or not the deodorization cartridge 40 is mounted on the first deodorization mechanism 20 based on a detection value of the first deodorization body sensor 28a. Further, the control unit 100 detects whether or not the lid portion 23 is closed based on a detection value of the first lid sensor 28b.

The second deodorization body sensor 58a and the second lid sensor 58b are coupled to the control unit 100. The control unit 100 can detect whether or not the deodorization cartridge 40 is mounted on the second deodorization mechanism 50 based on a detection value of the second deodorization body sensor 58a. The control unit 100 detects whether or not the lid portion 53 is closed based on a detection value of the second lid sensor 58b.

### 5. Configuration of Deodorization Body

FIG. 8 is a cross-sectional view of line A-A in FIG. 7.

A configuration of the deodorization unit 47 accommodated in the accommodating portion 21 will be described with reference to FIG. 8. The deodorization unit 47 includes activated carbon 101, a bag member 103, urethanes 105A and 105B, and nonwoven fabric sheets 107A and 107B. The urethane 105A corresponds to a first elastic body, and the urethane 105B corresponds to a second elastic body. The nonwoven fabric sheet 107A corresponds to a first nonwoven fabric, and the nonwoven fabric sheet 107B corresponds to a second nonwoven fabric.

The activated carbon 101 corresponds to an example of a deodorization body, and for example, pelletized carbon is used. A shape of the pelletized carbon is arbitrary, but may be, for example, a cylindrical shape.

The activated carbon 101 is accommodated in the bag member 103. For example, nonwoven fabric is used for the bag member 103.

The bag member 103 accommodating the activated carbon 101 is fixed at upper and lower locations in the Z-axis direction by the urethanes 105A and 105B within the accommodation portion 21. The Z-axis direction also corresponds to a ventilation direction within the deodorization cartridge 40. The ventilation direction is a direction in which the air inside the deodorization body cover 41 sucked by the first blower 27 moves. The urethane 105A is disposed on an upper side in the Z-axis direction, that is, an upper portion of the bag member 103, and the urethane 105B is disposed on a lower side in the Z-axis direction, that is, a lower portion of the bag member 103. The Z-axis direction corresponds to a first direction. The upper side in the Z-axis direction corresponds to one side in the first direction, and the lower side in the Z-axis direction corresponds to the other side in the first direction. The urethane 105A contacts and fixes the bag member 103 accommodating the activated carbon 101 from an upward direction, and the urethane 105A contacts and fixes the bag member 103 accommodating the activated carbon 101 from the downward direction.

The activated carbon 101 accommodated in the nonwoven bag member 103 generates a large amount of fine powder due to friction between the nonwoven fabric and the activated carbon 101. The activated carbon 101 is fixed by the upper urethane 105A and the lower urethane 105B so that the movement of the activated carbon 101 inside the bag member 103 is curbed, the friction is reduced, and the generation of the fine powder of the activated carbon 101 is reduced.

The urethanes 105A and 105B are accommodated in the accommodation portion 21 while being elastically deformed so that the urethanes 105A and 105B are crushed. Accordingly, a movement of the activated carbon 101 sandwiched from an up-down direction by the urethanes 105A and 105B due to vibration can be curbed, and powder falling from the activated carbon 101 can be reduced.

In the present embodiment, an example in which the urethanes 105A and 105B are disposed above and below the bag member 103 accommodating the activated carbon 101 is shown. The disposition of the urethanes 105A and 105B is not limited to locations on and beneath the bag member 103, and may be disposed in at least one of the left-right direction in the X-axis direction and the front-rear direction in the Y-axis direction in a state in which the deodorization cartridge 40 is accommodated in the accommodation portion 21 of the first deodorization mechanism 20.

The nonwoven fabric sheet 107A is disposed on the urethane 105A in the Z-axis direction, and the nonwoven fabric sheet 107B is disposed beneath the urethane 105B in the Z-axis direction.

The nonwoven fabric sheet 107A has a function of adsorbing ink mist that flows into the accommodation portion 21 according to a blowing operation of the first blower 27. When the ink mist enters the accommodation portion 21, a deodorizing effect of the activated carbon 101 may be greatly degraded, and thus, the ink mist flowing into the accommodation portion 21 is adsorbed by the nonwoven fabric sheet 107A.

The nonwoven fabric sheet 107B has a function of absorbing fine powder of the activated carbon 101 and preventing the fine powder from leaking to the outside. The nonwoven fabric sheet 107B is disposed downstream in the ventilation direction of the bag member 103 that accommodates the activated carbon 101.

The air flowing into the accommodation portion 21 from the first intake port 25 is sent to the deodorization unit 47 through the upper surface ventilation hole 42a according to the blowing operation of the first blower 27. In this case, it is possible to prevent fine powder of the activated carbon 101 from leaking from an opening formed in the bottom surface of the cover body 43 to the outside by providing the nonwoven fabric sheet 107B downstream in the ventilation direction.

### 6. Configuration of Control System of Recording Device

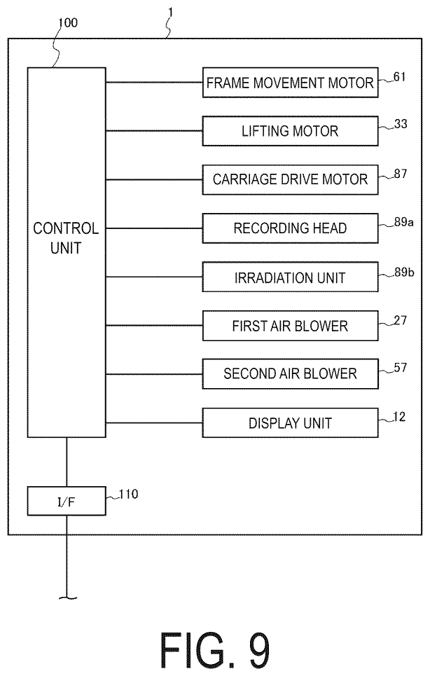

FIG. 9 is a block diagram illustrating a configuration of a control system of the recording device 1.

The recording device 1 includes a control unit 100. The control unit 100 includes a processor such as a central processing unit (CPU) or a micro processing unit (MPU), and a storage unit. The storage unit of the control unit 100 includes a volatile memory and a non-volatile storage unit. The volatile memory is, for example, a random access memory (RAM). The non-volatile storage unit includes a read only memory (ROM), a hard disk, a flash memory, or the like. The control unit 100 controls each portion of the recording device 1 by executing a program stored in the storage unit.

An interface (I/F) 110 is coupled to the control unit 100. The interface 110 is a communication device that executes wired communication using a cable, or wireless communication using a wireless communication line. The interface 110 executes communication with a host computer (not shown) and receives recording data. The recording data includes data of an image or character to be recorded on the medium M by the recording device 1, commands to instruct the recording device 1 to execute recording, and other data.

The lifting motor 33, the frame movement motor 61, the carriage drive motor 87, the recording head 89a, and the irradiation unit 89b are coupled to the control unit 100. Further, a display unit 12, the first blower 27, and the second blower 57 are coupled to the control unit 100. The control unit 100 controls the lifting motor 33, for example, to control the raising or lowering of the support surface 31m.

The control unit 100 operates each motor based on the recording data received by the interface 110. In detail, the control unit 100 moves the moving portion 70 forward and backward by controlling switching of the rotation direction of the frame movement motor 61 and the start and stop of the rotation of the frame movement motor 61. The control unit 100 controls the switching of the rotation direction of the lifting motor 33 and the start and stop of the rotation of the lifting motor 33 to move the table 31 in an up-down direction. The control unit 100 controls the switching of the carriage drive motor 87 and the start and stop of the rotation of the carriage drive motor 87 to move the carriage 89 in the left-right direction.

The control unit 100 performs recording by causing a liquid to be ejected from the recording head 89a onto the medium M, based on the recording data received by the interface 110. The control unit 101 also causes the irradiation unit 89b to irradiate the medium M on which recording has been performed with the irradiation light, and fixes a liquid adhered to the medium M to the medium M. The control unit 100 also operates the display unit 12 to cause the display unit 12 to display information. The control unit 100 operates the first blower 27 and the second blower 57 to deodorize the air inside the housing 10 and exhaust the air to the outside of the housing 10.

### 7. Other Embodiments

The above embodiment merely shows a specific example in which the present disclosure has been applied. The present disclosure is not limited to the configuration of the above embodiment, and can be implemented in various aspects without departing from the gist of the disclosure.

For example, in the above embodiment, a configuration in which the recording device 1 includes the first deodorization mechanism 20 and the second deodorization mechanism 50 has been illustrated, but this is only one example. For example, the recording device 1 may include three or more deodorization mechanisms.

Further, for example, in the embodiment, a configuration in which the first deodorization mechanism 20 exhausts air downward through the duct 29, and the second deodorization mechanism 50 exhausts air downward through the duct 59 has been described. In this configuration, the exhaust air of the first deodorization mechanism 20 and the exhaust air of the second deodorization mechanism 50 are exhausted toward the bottom plate 13 inside the housing 10. This is one example, and for example, the first deodorization mechanism 20 may be configured to include the duct 29 coupled to the outside of the housing 10 and exhaust air to the outside of the housing 10 through the duct 29. The same applies to the second deodorization mechanism 50.

Further, in the embodiment, a configuration in which the table 31 on which the medium M is placed is not moved in the direction along the X-axis and the direction along the Y-axis and the carriage 89 is moved has been described by way of example. An application target of the present disclosure is not limited to the configuration of the present embodiment. For example, of course, the present disclosure can be applied to a recording device in which the medium M is moved in at least one of the direction along the X-axis and the direction along the Y-axis when recording on the medium M is performed.

### 8. Conclusion of Present Disclosure

Hereinafter, a conclusion of the present disclosure with be described.

### APPENDIX 1

A deodorization cartridge for a recording device, including an accommodation body including a handle and an opening portion for ventilation, and a deodorization unit accommodated in the accommodation body, wherein the deodorization unit includes a deodorization body, and a first elastic body and a second elastic body disposed on both sides of the deodorization body in a first direction, the first elastic body and the second elastic body are accommodated in the accommodation body in an elastically deformed state, and the opening portion causes air in the accommodation body to flow therethrough in the first direction.

According to this configuration, the deodorization unit is accommodated in the accommodation body in a state in which the first elastic body and the second elastic body disposed on both sides of the deodorization body in the first direction have been elastically deformed. This makes it possible to curb the movement of the deodorization body due to vibration. Therefore, since the powder of the deodorization body may leak to the outside from the opening portion when the deodorization body is vibrated, it is possible to curb the leakage of the powder of the deodorization body to the outside by curbing the movement of the deodorization body due to vibration. Further, it is possible to lift the deodorization unit and accommodate the deodorization unit in the recording device without touching the deodorization unit, by the deodorization unit including the handle.

### APPENDIX 2

The deodorization cartridge according to Appendix 1, wherein
the first direction is a detachment direction when the deodorization cartridge is mounted on the recording device or removed from the recording device, and the first elastic body and the second elastic body are disposed to sandwich the deodorization unit from both sides in the detachment direction.

With this configuration, the first elastic body and the second elastic body are disposed to sandwich the deodorization unit from both sides in the detachment direction. This makes it possible to efficiently curb vibration when the deodorization unit is attached or detached.

### APPENDIX 3

The deodorization cartridge according to Appendix 1 or 2, wherein the first elastic body contacts the deodorization body from one side in the first direction, and the deodorization unit includes a first nonwoven fabric contacting the first elastic body from the one side in the first direction of the first elastic body.

According to this configuration, the deodorization unit includes the first nonwoven fabric that contacts the first elastic body from one side in the first direction of the first elastic body. For example, it is possible to curb entrance of impurities drawn in by the ventilation to the deodorization cartridge when the one side in the first direction is an upstream side in the ventilation direction. Further, it is possible to curb leakage of the powder of the deodorization body from the opening portion to the outside when the other side in the first direction is a downstream side in the ventilation direction.

### APPENDIX 4

The deodorization cartridge according to any one of Appendices 1 to 3, wherein the second elastic body contacts the deodorization body from the other side in the first direction, and the deodorization unit includes a second nonwoven fabric contacting the second elastic body from the other side in the first direction of the first elastic body.

According to this configuration, the deodorization unit includes the second nonwoven fabric that contacts the first elastic body from the other side in the first direction of the second elastic body. For example, it is possible to curb entrance of impurities drawn in by the ventilation to the deodorization cartridge when the one side in the first direction is an upstream side in the ventilation direction. Further, it is possible to curb leakage of the powder of the deodorization body from the opening portion to the outside when the other side in the first direction is a downstream side in the ventilation direction.

### APPENDIX 5

A recording device including a medium support portion configured to support a medium, a recording unit configured to perform recording on the medium using a liquid, an irradiation unit configured to irradiate the medium with ultraviolet light, and a deodorization cartridge configured to deodorize odors generated from the liquid, wherein the deodorization cartridge includes an accommodation body including a handle and an opening portion for ventilation, and a deodorization unit accommodated in the accommodation body, the deodorization unit includes a deodorization body, and a first elastic body and a second elastic body disposed on both sides of the deodorization body in a first direction, the first elastic body and the second elastic body are accommodated in the accommodation body in an elastically deformed state, and the opening portion causes air in the accommodation body to flow therethrough in the first direction.

According to this configuration, the deodorization unit is accommodated in the accommodation body in a state in which the first elastic body and the second elastic body disposed on both sides of the deodorization body in the first direction have been elastically deformed. This makes it possible to curb the movement of the deodorization body due to vibration. Therefore, since the powder of the deodorization body may leak to the outside from the opening portion when the deodorization body is vibrated, it is possible to curb the leakage of the powder of the deodorization body to the outside by curbing the movement of the deodorization body due to vibration. Further, it is possible to raise the deodorization unit and accommodate the deodorization unit in the recording device without touching the deodorization unit, by the deodorization unit including the handle.

### APPENDIX 6

The recording device according to Appendix 5, including a deodorizing fan, wherein the deodorizing fan is operated to ventilate the air within the accommodation body in the first direction.

According to this configuration, the recording device includes the deodorization fan and ventilates the air in the accommodation body in the first direction. Therefore, it is possible to ventilate the odor generated from the liquid to the deodorization body, and curb the odor generated from the liquid.

### APPENDIX 7

The recording device according to Appendix 5 or 6, including a deodorization mechanism configured to accommodate the deodorization cartridge, wherein the deodorization cartridge is accommodated in the deodorization mechanism via a resin member for shake prevention.

According to this configuration, the deodorization cartridge is accommodated in the deodorization mechanism through a resin member for shake prevention. This makes it possible to curb shaking of the deodorization cartridge and curb leakage of the powder of the deodorization body to the outside.

What is claimed is:

1. A deodorization cartridge for a recording device, comprising:
an accommodation body including a handle and an opening portion for ventilation; and
a deodorization unit accommodated in the accommodation body, wherein
the deodorization unit includes
a deodorization body; and
a first elastic body and a second elastic body disposed on both sides of the deodorization body in a first direction,
the first elastic body and the second elastic body are accommodated in the accommodation body in an elastically deformed state, and
the opening portion causes air in the accommodation body to flow therethrough in the first direction.

2. The deodorization cartridge according to claim 1, wherein
the first direction is a detachment direction when the deodorization cartridge is mounted on the recording device or removed from the recording device, and
the first elastic body and the second elastic body are disposed to sandwich the deodorization unit from both sides in the detachment direction.

3. The deodorization cartridge according to claim 1, wherein
the first elastic body is in contact with the deodorization body from one side in the first direction, and
the deodorization unit comprises a first nonwoven fabric in contact with the first elastic body from the one side in the first direction of the first elastic body.

4. The deodorization cartridge according to claim 3, wherein
the second elastic body is in contact with the deodorization body from the other side in the first direction, and
the deodorization unit includes a second nonwoven fabric in contact with the second elastic body from the other side in the first direction of the first elastic body.

5. A recording device comprising:
a medium support portion configured to support a medium;
a recording unit configured to perform recording on the medium using a liquid;
an irradiation unit configured to irradiate the medium with ultraviolet light; and
a deodorization cartridge configured to deodorize odors generated from the liquid, wherein
the deodorization cartridge includes
an accommodation body including a handle and an opening portion for ventilation; and
a deodorization unit accommodated in the accommodation body,
the deodorization unit includes
a deodorization body; and
a first elastic body and a second elastic body disposed on both sides of the deodorization body in a first direction, and
the first elastic body and the second elastic body are accommodated in the accommodation body in an elastically deformed state, and
the opening portion causes air in the accommodation body to flow therethrough in the first direction.

6. The recording device according to claim 5, comprising:
a deodorizing fan, wherein
the deodorizing fan is operated to ventilate the air within the accommodation body in the first direction.

7. The recording device according to claim 5, comprising:
a deodorization mechanism configured to accommodate the deodorization cartridge, wherein
the deodorization cartridge is accommodated in the deodorization mechanism via a resin member for shake prevention.
